(19) United States
(12) Patent Application Publication
(10) Pub. No.: US 2023/0192987 A1
(43) Pub. Date: Jun. 22, 2023

(54) AMMONIUM OCTAMOLYBDATE METAL HYDROXIDE COMPLEXES AND USES THEREOF AS SMOKE SUPPRESSANTS

(71) Applicant: J.M. Huber Corporation, Atlanta, GA (US)

(72) Inventors: Yue LIU, Marietta, GA (US); Aleksey ISAROV, Kennesaw, GA (US); Robin Brumby HELMS, Ranger, GA (US); Erin Combes PROWETT, Adairsville, GA (US)

(21) Appl. No.: 18/067,782

(22) Filed: Dec. 19, 2022

Related U.S. Application Data
(60) Provisional application No. 63/291,991, filed on Dec. 21, 2021.

(51) Int. Cl. C08K 3/22; C08K 9/02; C08K 7/18; C01G 39/00

(52) U.S. Cl. CPC C08K 3/22; C08K 9/02; C08K 7/18; C01G 39/006; C08K 2201/005; C08K 2201/006; C08K 2003/2255; C08K 2003/2227; C01P 2002/72; C01P 2006/60; C01P 2004/62; C01P 2004/61; C01P 2006/12; C01P 2006/80

(57) ABSTRACT

Processes for producing ammonium octamolybdate/metal hydroxide complexes include the steps of pre-contacting ammonium dimolybdate and a metal hydroxide, and then contacting molybdenum trioxide, to form the ammonium octamolybdate/metal hydroxide complexes. The resulting complexes contain the metal hydroxide and from 1 to 95 wt. % of ammonium octamolybdate, and generally, at least 80 wt. % of the ammonium octamolybdate in the complex is present in an orthorhombic crystalline form. These ammonium octamolybdate/metal hydroxide complexes can be used as smoke suppressants in polymer compositions, such as PVC-based and epoxy-based formulations.

### REFERENCE TO RELATED APPLICATION

This application claims the benefit of U.S. Provisional Patent Application No. 63/291,991, filed on Dec. 21, 2021, the disclosure of which is incorporated herein by reference in its entirety.

### BACKGROUND OF THE INVENTION

The present invention is directed generally to smoke suppressants used in polymer compositions, and more particularly, to ammonium octamolybdate/metal hydroxide complexes that can be used as smoke suppressants in polymer compositions.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Processes for producing ammonium octamolybdate/metal hydroxide complexes are disclosed and described herein. One such process can comprise reacting ammonium dimolybdate (ADM), molybdenum trioxide (MoO₃), and a metal hydroxide—in any order—in an aqueous system to form the ammonium octamolybdate/metal hydroxide complex. For instance, the process can comprise pre-contacting the ammonium dimolybdate (ADM) with the metal hydroxide, and then contacting the molybdenum trioxide (MoO₃), to form the ammonium octamolybdate/metal hydroxide complex.

Ammonium octamolybdate/metal hydroxide complexes also are disclosed and described herein, and these complexes can comprise (i) ammonium octamolybdate (AOM) and (ii) a metal hydroxide, and the amount of the AOM present in the complex can range from 1 to 95 wt. %, such as from 5 to 80 wt. %, from 5 to 50 wt. %, from 10 to 60 wt. %, or from 10 to 30 wt. %, and the like. Generally, at least 80 wt. %, and more often at least 85, 90, 95, 98, or 99 wt. %, of the ammonium octamolybdate in the complex is present in an orthorhombic crystalline form.

Polymer compositions also are provided herein, and such compositions can comprise a polymer and any of the ammonium octamolybdate/metal hydroxide complexes disclosed herein (e.g., produced by any of the processes disclosed herein). The relative amounts of the polymer and the ammonium octamolybdate/metal hydroxide complex in the composition are not particularly limited, nor is the polymer type, although the ammonium octamolybdate/metal hydroxide complex is particularly well suited as a smoke suppressant for use in PVC and epoxy-based formulations.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

FIG. 1 presents an x-ray diffraction (XRD) plot of the powder complex produced in Example 1.

FIG. 2 presents an x-ray diffraction (XRD) plot of the powder complex produced in Example 2.

FIG. 3 presents an x-ray diffraction (XRD) plot of the ammonium octamolybdate mixture produced in Example 9.

FIG. 4 presents a bar chart of the normalized total smoke for the flexible PVC polymer compositions of Examples 1-2 and 8-9, and a Control Example.

FIG. 5 presents a bar chart of the normalized total smoke for the flexible PVC polymer compositions of Examples 1A-1B, and a Control Example.

FIG. 6 presents a bar chart of the total smoke for the flexible PVC polymer compositions of Example 1C, Example 10, and a Control Example.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and each and every feature disclosed herein, all combinations that do not detrimentally affect the designs, compositions, processes, or methods described herein are contemplated and can be interchanged, with or without explicit description of the particular combination. Accordingly, unless explicitly recited otherwise, any aspect or feature disclosed herein can be combined to describe inventive designs, compositions, processes, or methods consistent with the present disclosure.

While compositions and methods are described herein in terms of “comprising” various components or steps, the compositions and methods also can “consist essentially of” or “consist of” the various components or steps, unless stated otherwise. The terms “a,” “an,” and “the” are intended to include plural alternatives, e.g., at least one, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, and so forth.

The term “contacting” is used herein to refer to materials or components which can be blended, mixed, slurried, dissolved, reacted, treated, compounded, or otherwise contacted or combined in some other manner or by any suitable method. The materials or components can be contacted together (or reacted) in any order, in any manner, and for any length of time, unless otherwise specified.

Molybdenum trioxide (MoO₃) often can be referred to as molybdic trioxide, molybdenum (VI) oxide, and molybdic anhydride (or molybdic acid anhydride). As one of skill in the art would readily recognize, in an (acidic) aqueous environment, molybdenum trioxide can form molybdic acid and other species such as hydrates and molybdates. Thus, when the use of molybdenum trioxide in an aqueous mixture or aqueous system is disclosed herein, this is meant to encompass any forms of molybdenum species or complexes that exist in the aqueous environment, whether molybdic acid, a hydrate, a molybdate, and the like, as well as combinations thereof.

Ammonium octamolybdate (AOM) has CAS Number 12411-64-2 and chemical formula (NH₄)₄·Mo₈O₂₆, which often is represented as 4(NH₄)⁺·(Mo₈O₂₆)⁴⁻.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. As a representative example, the amount of the ammonium octamolybdate/metal hydroxide complex in a polymer composition or formulation can be in certain ranges in various aspects of this invention. By a disclosure that the amount of the complex in the polymer composition or formulation can be in a range from 1 to 50 phr, the intent is to recite that the amount of the complex can be any phr within the range and, for example, can be in any range or combination of ranges from 1 to 50 phr, such as from 5 to 50 phr, from 2 to 40 phr, from 5 to 40 phr, from 10 to 50 phr, from 10 to 40 phr, from 10 to 30 phr, or from 15 to 40 phr, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

### DETAILED DESCRIPTION OF THE INVENTION

Disclosed herein are ammonium octamolybdate/metal hydroxide complexes containing a metal hydroxide and ammonium octamolybdate (AOM) predominantly in the orthorhombic crystalline form, methods for producing the ammonium octamolybdate/metal hydroxide complexes, and polymer compositions and articles of manufacture containing the ammonium octamolybdate/metal hydroxide complexes.

An objective of this invention is to provide improved smoke suppressant performance over that of zinc molybdate on a borate core material. Another objective of this invention is provide improved smoke suppressant performance over ammonium octamolybdate (AOM) on an inert core material. AOM is an effective smoke suppressant, particularly in PVC-based compositions, but it is expensive, so it is has been conventionally used in minor amounts (e.g., less than 50 wt. %) on an inert core material.

### Processes for Producing the Complexes

Various processes for producing an ammonium octamolybdate/metal hydroxide complex are provided herein. One such process can comprise (or consist essentially of, or consist of) reacting ammonium dimolybdate (ADM), molybdenum trioxide (MoO₃), and a metal hydroxide in an aqueous system to form the ammonium octamolybdate/metal hydroxide complex. Generally, the features of any of the processes disclosed herein (e.g., the ammonium dimolybdate, the molybdenum trioxide, the metal hydroxide, the aqueous system, the ammonium octamolybdate/metal hydroxide complex, and conditions under which the complex is formed, among others) are independently described herein, and these features can be combined in any combination to further describe the disclosed processes. Moreover, other process steps can be conducted before, during, and/or after any of the steps listed in the disclosed processes, unless stated otherwise. Additionally, any ammonium octamolybdate/metal hydroxide complexes produced in accordance with any of the disclosed processes are within the scope of this disclosure and are encompassed herein.

The process for producing the ammonium octamolybdate/metal hydroxide complex can be conducted and the complex can be formed at a temperature that typically falls within a range from 20° C. to 98° C., such as from 50° C. to 90° C., from 75° C. to 90° C., from 80° C. to 98° C., from 80° C. to 90° C., or from 83° C. to 93° C., although not limited thereto. In these and other aspects, these temperature ranges also are meant to encompass circumstances where the ammonium octamolybdate/metal hydroxide complex is formed at a series of different temperatures, instead of at a single fixed temperature, falling within the respective ranges. The pressure at which the process is conducted and the complex is formed is not particularly limited, but can be at an elevated pressure (e.g., from 5 psig to 100 psig), at atmospheric pressure, or at any suitable sub-atmospheric pressure. In some instances, the complex is formed at atmospheric pressure, eliminating the need for pressurized vessels and their associated cost and complexity. The process can be conducted and the complex can be formed over a wide range of time periods, such as from 15 min to 24 hr, from 30 min to 12 hr, from 90 min to 6 hr, or from 2 hr to 10 hr, but is not limited solely to these time periods. Other appropriate temperature, pressure, and time ranges are readily apparent from this disclosure.

In the process, ammonium dimolybdate (ADM), molybdenum trioxide (MoO₃), and a metal hydroxide are contacted in an aqueous system to form the ammonium octamolybdate/metal hydroxide complex. Any suitable metal hydroxide compound can be used, such as alkali metal hydroxides, alkaline earth metal hydroxides, and the like, as well as combinations thereof. Generally, such metal hydroxides can function as inorganic flame retardants. In one aspect, the metal hydroxide can comprise aluminum trihydroxide (also referred to herein as Al(OH)₃, aluminum hydroxide, alumina trihydrate, or ATH), while in another aspect, the metal hydroxide can comprise magnesium dihydroxide (also referred to herein as Mg(OH)₂, magnesium hydroxide, or MDH), and in yet another aspect, the metal hydroxide can comprise a mixture of ATH and MDH. Any suitable amount of the metal hydroxide can be used, relative to the total amount of the reactants, such as from 1 to 99 wt. %, but generally, the amount of the metal hydroxide is from 20 to 90 wt. %, from 50 to 90 wt. %, or 70 to 90 wt. %, based on the total amount of the reactants.

The molybdenum trioxide (MoO₃) and the ammonium dimolybdate (ADM) can be contacted or reacted at a molar ratio of MoO₃:ADM that typically falls within a range from 1:1 to 3:1, based on the total amount of each reactant, and regardless of the order of addition or contacting of the reactants, or the addition method that is used. For instance, the process can be performed by contacting the ammonium dimolybdate (ADM), the molybdenum trioxide (MoO₃), and the metal hydroxide substantially contemporaneously. Alternatively, the process can be performed by pre-contacting the ammonium dimolybdate (ADM) and the metal hydroxide, and then contacting the molybdenum trioxide (MoO₃). The molybdenum trioxide (e.g., a slurry in water) can be added slowly—at any suitable rate of addition—to the mixture of ADM and the metal hydroxide in water over any suitable period of time. As a skilled artisan would readily recognize, the molar ratio of MoO₃:ADM can vary as the reaction proceeds; therefore, the disclosed ranges of molar ratio encompass any molar ratio encountered during the reaction and formation of the complex. In further aspects of this invention, the molar ratio of MoO₃:ADM can range from 1.2:1 to 2.8:1, from 1.5:1 to 2.5:1, or from 1.8:1 to 2.4:1, based on the total amount of each reactant. For instance, the molar ratio of MoO₃:ADM can be a stoichiometric ratio of 2:1 (+/−10%), reflective of the resulting ammonium octamolybdate having the formula (NH₄)₄·Mo₈O₂₆.

The process to form the ammonium octamolybdate/metal hydroxide complex is conducted in an aqueous system. The aqueous system can comprise (or consist essentially of, or consist of) water. The pH of the aqueous system is not particularly limited, and as a skilled artisan would readily recognize, the pH of the aqueous system, and the pH at which the ammonium octamolybdate/metal hydroxide complex is formed, can vary as the reactions proceeds, particularly if one reactant is added slowly to the other reactant(s). If desired, the aqueous system can comprise an acid or a base to modify the pH or to control the pH in a certain range during the process. Once all of the molybdenum trioxide (MoO₃) is present in the reaction mixture, it is not unusual for the pH to fall within the range of 1.5 to 4.

In some aspects, the d50 particle size (median particle size) of the molybdenum trioxide can be in a range from 0.5 to 20 μm, such as, for instance, from 0.5 to 6 μm, from 1 to 10 μm, from 1 to 6 μm, from 1.6 to 6 μm, or from 1.6 to 4 μm. Additionally or alternatively, the d50 particle size (median particle size) of the metal hydroxide can be in a range from 0.5 to 5 μm, such as from 0.5 to 3 μm, from 0.75 to 2 μm, or from 0.75 to 1.75 μm. Other appropriate particle sizes for the molybdenum trioxide and the metal hydroxide (e.g., ATH) are readily apparent from this disclosure.

Consistent with aspects of this invention, the metal hydroxide can contain less than or equal to 29 ppm (by weight) of gallium, as measured by ICP-OES. More often, the metal hydroxide (e.g., ATH, MDH, or a mixture of ATH and MDH) comprises less than or equal to 27 ppm in one aspect, less than or equal to 25 ppm in another aspect, less than or equal to 23 ppm in another aspect, less than or equal to 20 ppm in another aspect, less than or equal to 15 ppm in yet another aspect, or less than or equal to 10 ppm of gallium in still another aspect. The ppm by weight of gallium is determined via ICP-OES (Inductively Coupled Plasma Optical Emission Spectroscopy).

The metal hydroxide can have any suitable BET surface area, such as from 1 to 20 m²/g in one aspect, from 1 to 15 m²/g in another aspect, from 2 to 10 m²/g in yet another aspect, and from 2 to 6 m²/g in still another aspect. The metal hydroxide can be further characterized by a low content of soluble Na₂O, generally encompassing a range from 0.001 to 0.035 wt. %. Other typical ranges for the amount of soluble Na₂O in the metal hydroxide include from 0.001 to 0.03 wt. %, from 0.001 to 0.018 wt. %, from 0.002 to 0.035 wt. %, from 0.002 to 0.025 wt. %, or from 0.002 to 0.02 wt. %, and the like. Moreover, the metal hydroxide can be further characterized by a high TAPPI brightness, which is greater than or equal to 95%, and more often, greater than or equal to 97%, greater than or equal to 98%, or greater than or equal to 99%. In a particular aspect of this invention, the metal hydroxide comprises (or consists essentially of, or consists of) precipitated ATH.

Optionally, the process for producing the ammonium octamolybdate/metal hydroxide complex can further comprise a step of removing the ammonium octamolybdate/metal hydroxide complex from the water (slurry) using any suitable separations technique. For example, filtration or centrifugation can be used, as well as a combination of these techniques.

Optionally, the process for producing the ammonium octamolybdate/metal hydroxide complex can further comprise a step of drying the ammonium octamolybdate/metal hydroxide complex using any suitable drying conditions. For example, drying temperatures ranging from 50° C. to 200° C., or from 100° C. to 150° C., can be used, and the drying can be conducted at atmospheric pressure or any suitable sub-atmospheric pressure, e.g., less than 150 Torr, or less than 50 Torr.

If desired, the process for producing the ammonium octamolybdate/metal hydroxide complex can further comprise a step of deagglomerating the ammonium octamolybdate/metal hydroxide complex, can further comprise a step of milling the ammonium octamolybdate/metal hydroxide complex (e.g., ACM milling), or both a deagglomerating step and a milling step can be utilized.

### Ammonium Octamolybdate/Metal Hydroxide Complexes

Consistent with aspects of the present invention, the ammonium octamolybdate/metal hydroxide complexes described herein (or the ammonium octamolybdate/metal hydroxide complexes produced in accordance with any of the processes disclosed herein) can be used in variety of polymer formulations with beneficial smoke suppressant properties. In an aspect, the ammonium octamolybdate/metal hydroxide complex can comprise (i) ammonium octamolybdate (AOM) and (ii) a metal hydroxide, in which the complex can contain from 1 to 95 wt. % AOM in one aspect, from 5 to 80 wt. % AOM in another aspect, from 5 to 50 wt. % AOM in another aspect, from 10 to 60 wt. % AOM in yet another aspect, and from 10 to 30 wt. % AOM in still another aspect. Other suitable ranges for the amount of AOM in the complex include from 10 to 35 wt. %, from 15 to 35 wt. %, from 15 to 25 wt. %, and the like.

Generally, at least 80 wt. % of the ammonium octamolybdate in the complex is present in an orthorhombic crystalline form. For instance, in one aspect, at least 85 wt. % can be present in the orthorhombic crystalline form, while in another aspect, at least 90 wt. % can be present in the orthorhombic crystalline form, and in yet another aspect, at least 95 wt. % can be present in the orthorhombic crystalline form. In some aspects consistent with this invention, at least 98 wt. %, or at least 99 wt. %, of the ammonium octamolybdate in the complex is present in the orthorhombic crystalline form. Thus, substantially all (98-99+wt. %) or all (100 wt. %) of the ammonium octamolybdate can be present in the orthorhombic crystalline form.

Consistent with aspects of this invention, the ammonium octamolybdate/metal hydroxide complex often can contain less than or equal to 29 ppm (by weight) of gallium, as measured by ICP-OES (Inductively Coupled Plasma Optical Emission Spectroscopy). More often, the ammonium octamolybdate/metal hydroxide complex (e.g., AOM-ATH complex) comprises less than or equal to 27 ppm in one aspect, less than or equal to 25 ppm in another aspect, less than or equal to 23 ppm in another aspect, less than or equal to 20 ppm in another aspect, less than or equal to 15 ppm in another aspect, less than or equal to 10 ppm in yet another aspect, or less than or equal to 5 ppm of gallium in still another aspect. The amount of gallium in the complex can vary significantly based on the relative amount of AOM and metal hydroxide (e.g., ATH) present in the complex. For instance, if the complex contains approximately 20 wt. % AOM and 80 wt. % ATH, ordinarily the gallium content of the complex will be less than or equal to 23 ppm, and more often, less than or equal to 20 ppm, less than or equal to 16, less than or equal to 12 ppm, less than or equal to 8 ppm, or less than or equal to 4 ppm.

While not being limited thereto, the ammonium octamolybdate/metal hydroxide complex often can have a median particle size (d50) in a range from 0.5 to 10 μm, from 0.5 to 4 μm, from 1 to 10 μm, from 1 to 6 μm, or from 1 to 3 μm. Additionally or alternatively, the complex can have any suitable BET surface area, such as from 2 to 20 m²/g (or from 2 to 12 m²/g) in one aspect, from 3 to 18 m²/g (or from 3 to 10 m²/g) in another aspect, from 4 to 15 m²/g (or from 4 to 8 m²/g) in yet another aspect, and from 5 to 12 m²/g (or from 5 to 9 m²/g) in still another aspect. Other appropriate particle sizes and surface areas are readily apparent from this disclosure.

The metal hydroxide component of the ammonium octamolybdate/metal hydroxide complex (or the complex) can be characterized by a low content of soluble Na₂O, generally encompassing a range from 0.001 to 0.035 wt. %, as discussed above. Likewise, other typical ranges for the amount of soluble Na₂O in the metal hydroxide component (or the complex) include from 0.001 to 0.03 wt. %, from 0.001 to 0.018 wt. %, from 0.002 to 0.035 wt. %, from 0.002 to 0.025 wt. %, or from 0.002 to 0.02 wt. %, and the like. Moreover, the metal hydroxide component of the complex (or the complex) can be further characterized by a high TAPPI brightness, which is greater than or equal to 95%, and more often, greater than or equal to 97%, greater than or equal to 98%, or greater than or equal to 99%.

Unlike a simple mixture of ammonium octamolybdate and metal hydroxide, in which the individual components can be readily separated, the herein described ammonium octamolybdate/metal hydroxide complex generally comprises AOM bound to the metal hydroxide. Thus, the ammonium octamolybdate and metal hydroxide components are bound together or intertwined to form a complex. And, in this complex, the individual components cannot be readily separated like a simple mixture. A majority of the metal hydroxide can be present in a core of the complex, with a majority of the AOM present in an outer shell, although not limited thereto.

Also while not limited thereto, in some aspects of this invention, the ammonium octamolybdate/metal hydroxide complex (or the ammonium octamolybdate/metal hydroxide complex produced by any process described herein) can be spherical—an average aspect ratio in a range from 1:1 to 1.5:1, and in some aspects, the average aspect ratio can be from 1:1 to 1.3:1 or from 1:1 to 1.2:1. The aspect ratio is defined herein as the longest (measurable) particle dimension divided by the shortest dimension when viewed in a 2-dimensional SEM image. The average aspect ratio is the average of the aspect ratios of 10 (measurable) particles from the SEM image.

### Polymer Compositions

This invention is also directed to, and encompasses, any compositions, formulations, composites, and articles of manufacture that contain any of the ammonium octamolybdate/metal hydroxide complexes disclosed herein (and their respective characteristics or features, such as surface area, particle size, soluble Na₂O content, crystalline form, and so forth). In a particular aspect of this invention, a polymer composition is disclosed, and in this aspect, the polymer composition can comprise any suitable polymer (one or more than one) and any of the ammonium octamolybdate/metal hydroxide complexes disclosed herein (or the ammonium octamolybdate/metal hydroxide complexes produced by any process described herein).

In one aspect, the polymer in the polymer composition can comprise a thermoplastic polymer, while in another aspect, the polymer can comprise a thermoset polymer. In another aspect, the polymer can comprise, either singly or in any combination, a polyvinylidene chloride (PVDC), a polyvinyl chloride (PVC), a chlorinated polyvinyl chloride (CPVC), a polyvinylidene fluoride (PVDF), a polytetrafluoroethylene (PTFE), and/or an ethylene chlorotrifluoroethylene (ECTFE). In yet another aspect, the polymer can comprise a plasticized or non-plasticized PVC. In still another aspect, the polymer can comprise a rigid PVC, or alternatively, the polymer can comprise a flexible PVC. Generally, rigid PVC may be referred to as non-plasticized PVC, while flexible PVC may be referred to as plasticized PVC.

As one of skill in the art would readily recognize, PVDC can be referred to as polyvinylidene chloride, but also can be referred to as poly(vinylidene chloride). Likewise, PVC can be referred to as polyvinyl chloride, but also can be referred to as poly(vinyl chloride).

In an aspect, the polymer can comprise an epoxy resin. For instance, the polymer can comprise, either singly or in any combination, a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton, an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, and/or an alicyclic epoxy resin.

While not being limited thereto, the amount of the ammonium octamolybdate/metal hydroxide complex in the polymer composition often can range from 1 to 50 phr (parts by weight per hundred parts of resin). Illustrative and non-limiting amounts of the ammonium octamolybdate/metal hydroxide complex in the polymer composition, therefore, can include the following ranges: from 5 to 50 phr, from 2 to 40 phr, from 5 to 40 phr, from 10 to 50 phr, from 10 to 40 phr, from 10 to 30 phr, or from 15 to 40 phr. Other appropriate ranges for the amount of the ammonium octamolybdate/metal hydroxide complex in the polymer composition are readily apparent from this disclosure.

Optionally, the polymer composition can further comprise any suitable additive, non-limiting examples of which can include a stabilizer, a lubricant, an inorganic flame retardant (e.g., aluminum trihydrate or magnesium hydroxide), a filler, a colorant, or a curing agent, and the like, as well as combinations thereof.

Articles of manufacture can be formed from and/or can comprise any of the polymer compositions described herein. In one aspect, the article of manufacture can comprise a wire or cable, while in another aspect, the article can comprise a printed circuit board. Other appropriate articles of manufacture and end-use applications are readily apparent from this disclosure.

For instance, the ammonium octamolybdate/metal hydroxide complexes can be utilized in at least three applications in industrial composite prepregs, as well as in microelectronic manufacturing to provide benefits in enhanced properties of finished products and improved manufacturing processes. The first application is in printed circuit boards (PCBs), the second application is in epoxy molding compounds (EMCs) as in microchip packaging, and the third application is industrial composite prepregs where flame retardancy as well as drilling are required, such as aerospace and automotive end-uses.

Printed circuit boards (PCBs) are ubiquitous in electronics in consumer and industrial products, including televisions, cell phones, and computers. Manufacturers commonly produce circuit boards with flame-retardant chemicals to help ensure fire safety. The flame retardant may prevent the fire from developing altogether or slow down the build-up phase of the fire by delaying the onset of flash over, thereby extending the escape time window. In either case, the flame retardant serves its primary purpose of reducing the risk of fire-related fatalities. Some flame-retardant chemicals, however, have caused growing concerns about their fate and toxicity if released into the environment. Such is the case for tetrabromobisphenol-A or TBBPA. TBBPA is the most widely used flame retardant for PCBs. Herein, a single composition offers several benefits including halogen-free flame retardancy, drilling improvements, thermal expansion control, and dimension stability.

A basic PCB consists of a flat sheet of insulating material and a layer of copper foil, laminated to the substrate. Chemical etching divides the copper into separate conducting lines called tracks or circuit traces, pads for connections, vias to pass connections between layers of copper, and features such as solid conductive areas for electromagnetic shielding or other purposes. A printed circuit board can have multiple copper layers. A two-layer board has copper on both sides; multi-layer boards sandwich additional copper layers between layers of insulating material. Conductors on different layers are connected with vias, which are copper-plated holes that function as electrical tunnels through the insulating substrate. Through-hole component leads sometimes also effectively function as vias. The “through-hole” components are mounted by their wire leads passing through the board and soldered to traces on the other side. Through-hole manufacture adds to board cost by requiring many holes to be drilled accurately. Holes through a PCB with a diameter larger than 76.2 micrometers are typically drilled with drill bits made of solid coated tungsten carbide. Beneficially, the disclosed compositions have high thermal stability, suitable for lead-free soldering.

Important characteristics are the level to which the laminate is fire retardant, the dielectric constant (er), the loss factor (tδ), the tensile strength, the shear strength, the glass transition temperature (Tg), and the Z-axis expansion coefficient (how much the thickness changes with temperature). Thermal expansion is an important consideration especially with ball grid array (BGA) and naked die technologies, and glass fiber generally offers the best dimensional stability. With decreasing size of board features and increasing frequencies, small non-homogeneities like uneven distribution of fiberglass or other filler, thickness variations, and bubbles in the resin matrix, and the associated local variations in the dielectric constant, are gaining importance. The small particle size of the disclosed complexes is consistent with these concerns.

The complexes described herein can be used as fillers in epoxy molding compound (EMC). Epoxy molding compounds are widely used to encapsulate semiconductor devices due to superior properties such as high mechanical strength and high productivity. Generally, in doing so, liquid epoxy polymers are injected over a circuit and cured to solid for protection. Herein, the complexes impart an extremely low coefficient of thermal expansion (CTE), good dimension stability, as well as flame retardancy to the semiconductor device packaging without significantly increasing viscosity during manufacturing processes.

Referring to industrial composite prepreg applications, prepreg stands for “pre-impregnated” composite fibers. More specifically, prepregs are composite materials where reinforcement fiber is pre-impregnated with a thermoplastic or thermoset resin matrix. It is a composite material form that requires additional conversion or fabrication into a final, fully cured, part. Epoxy resins are the most common thermoset polymer matrix material. The fibers often take the form of a weave and the matrix is used to bond them together and to other components during manufacture. The thermoset matrix is only partially cured to allow easy handling. This partially cured epoxy material is also called B-Stage material. Composite prepregs increasingly find use in high performance applications in various industrial sectors. Some examples of the use of prepregs are aircraft interiors, aerospace components, aircraft flooring, cargo liners, automotive parts and components, tooling, ballistic panels, electronic-transmission applications, sporting goods, high-rise flooring, high impact floor surfaces, rotor blades in wind turbines, and orthopedic technology in orthotics as well as in prosthetics. Added as a filler, the complexes described herein provide required flame retardancy, very low coefficient of thermal expansion (CTE), and good dimensional stability.

The complexes also can be used in Thermal Interface Materials due to high thermal conductivity and the low viscosity resulting from the sphericity of particles. The complexes may also be surface treated with silane and other surfactants, such as epoxy silane, phenylamino silane, methacryl silane, isocyanate silane, and the like. After surface treatment, improved compound properties can be achieved. The benefits include lower resin compound viscosity, better compatibility with polymer resins, and less agglomerations.

If desired, closed packing technology can be applied to the complexes, such as, for instance, combinations of larger particles of the complex with smaller particles of the complex (e.g., a bimodal particle size distribution) instead of a single particle size distribution. This can improve compound viscosity at very high loading levels (up to 80 wt. %, or more).

### EXAMPLES

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

The d50 particle size, or median particle size, refers to the particle size for which 50% of the sample by weight has a smaller size and 50% of the sample has a larger size. Particle size measurements were determined by laser diffraction in accordance with ISO 13320 using a Beckman Coulter LS 13 320 Single-Wavelength Laser Diffraction Particle Size Analyzer.

BET surface areas were determined using the BET nitrogen adsorption method of Brunauer et al., J. Am. Chem. Soc., 60, 309 (1938) using a Micromeritics TriStar II Surface Area and Porosity Analyzer.

The soluble Na₂O content (wt. %) was determined by flame emission photometry, and TAPPI brightness was determined in accordance with test method T452.

### Examples 1-9

In Example 1, 177.0 g (520.7 mmol) of ammonium dimolybdate (d50 of 20-25 μm, Climax Molybdenum Company) and 3.3 L of deionized water were placed in a reactor vessel equipped with a stirrer and a thermoregulator, and heated with stirring at 88° C. Once the ammonium dimolybdate was completely dissolved, 1308.0 g of fine precipitated aluminum hydroxide (ATH, Hydral 710, Huber Engineered Materials, produced from ground aluminum hydroxide via a digestion and recrystallization process, d50 of 1.1 μm, BET of 4 m²/g, 0.016 wt. % soluble Na₂O, 99+% brightness, conductivity of 13.4 μS/cm) were added to the ammonium dimolybdate solution. The precipitated ATH contained a range of 20-22 ppm by weight of gallium (three tests), as measured by ICP-OES. Separately, 150.0 g (1042.1 mmol) of molybdenum trioxide (Langeloth Metallurgical Company) and 600.0 g of deionized water were added to a beaker at 88° C. to create a slurry. Once both were well mixed, the molybdenum trioxide slurry was pumped into the reactor vessel containing the ammonium dimolybdate solution with fine precipitated aluminum hydroxide particles at 8 mL/min with a peristaltic pump. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution (d50 of approximately 2.5 μm and BET of approximately 8 m²/g).

In Example 2, 177.0 g (520.7 mmol) of ammonium dimolybdate (d50 of 20-25 μm, Climax Molybdenum Company) and 3.3 L of deionized water were placed in a reactor vessel equipped with a stirrer and a thermoregulator, and heated with stirring at 88° C. Once the ammonium dimolybdate was completely dissolved, 1308.0 g of ground aluminum hydroxide (ATH, Micral 932, Huber Engineered Materials, produced from bauxite ore using the Bayer process, d50 of 2 μm, BET of 13 m²/g, 0.05 wt. % soluble Na₂O, 93% brightness, conductivity of 93.2 μS/cm) were added to the ammonium dimolybdate solution. The ground ATH contained a range of 30-31 ppm by weight of gallium (three tests), as measured by ICP-OES. Separately, 150.0 g (1042.1 mmol) of molybdenum trioxide (Langeloth Metallurgical Company) and 600.0 g of deionized water were added to a beaker at 88° C. to create a slurry. Once both were well mixed, the molybdenum trioxide slurry was pumped into the reactor vessel containing the ammonium dimolybdate solution with ground aluminum hydroxide particles at 8 mL/min with a peristaltic pump. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution (d50 of approximately 2.5 μm and BET of approximately 8 m²/g).

In Example 3, 81.7 g (567.6 mmol) of molybdenum trioxide (Langeloth Metallurgical Company) and 3.1 L of deionized water were placed in a reactor vessel equipped with a stirrer and a thermoregulator, and heated with stirring at 88° C. Once the molybdenum trioxide was completely dissolved, 704.0 g of fine precipitated aluminum hydroxide (ATH, Hydral 710) were added to the molybdenum trioxide solution. Separately, 98.2 g (288.9 mmol) of ammonium dimolybdate (d50 of 20-25 μm, Climax Molybdenum Company) and 400.0 g of deionized water were added to a beaker at 88° C. to create a slurry. Once both were well mixed, the ammonium dimolybdate solution was pumped into the reactor vessel containing the molybdenum trioxide solution with fine precipitated aluminum hydroxide particles at 8 mL/min with a peristaltic pump. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 4, 81.7 g (567.6 mmol) of molybdenum trioxide (Langeloth Metallurgical Company) and 3.1 L of deionized water were placed in a reactor vessel equipped with a stirrer and a thermoregulator, and heated with stirring at 88° C. Once the molybdenum trioxide was completely dissolved, 704.0 g of ground aluminum hydroxide (ATH, Micral 932) were added to the molybdenum trioxide solution. Separately, 98.2 g (288.9 mmol) of ammonium dimolybdate (d50 of 20-25 μm, Climax Molybdenum Company) and 400.0 g of deionized water were added to a beaker at 88° C. to create a slurry. Once both were well mixed, the ammonium dimolybdate solution was pumped into the reactor vessel containing the molybdenum trioxide solution with ground aluminum hydroxide particles at 8 mL/min with a peristaltic pump. The reaction mixture was then stirred for 8 hours at 88° C. The product mixture was then poured into glass pan and dried in an oven at 120° C. overnight. The dried product was deagglomerated in a Henschel at 1800 rpm for 3 minutes followed by hammer milling to reduce to a specified particle size distribution.

In Example 5, 49.1 g (144.4 mmol) of ammonium dimolybdate (d50 of 20-25 μm, Climax Molybdenum Company) and 1.6 L of deionized water were placed in a reactor vessel equipped with a stirrer and a thermoregulator, and heated with stirring at 88° C. Once the ammonium dimolybdate was completely dissolved, 352.1 g of zinc borate (Firebrake ZB Fine, U.S. Borax) were added to the ammonium dimolybdate solution. Separately, 40.9 g (284.1 mmol) of molybdenum trioxide (Langeloth Metallurgical Company) and 200.0 g of deionized water were added to a beaker at 88° C. to create a slurry. Once both were well mixed, the molybdenum trioxide slurry was pumped into the reactor vessel containing the ammonium dimolybdate solution with zinc borate particles at 8 mL/min with a peristaltic pump. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 6, 80.0 g (555.8 mmol) of molybdenum trioxide (Langeloth Metallurgical Company) and 3.2 L of deionized water were placed in a reactor vessel equipped with a stirrer and a thermoregulator, and heated with stirring at 88° C. Once the molybdenum trioxide was completely dissolved, 700.0 g of zinc borate (Firebrake ZB Fine) were added to the molybdenum trioxide solution. Separately, 96.0 g (282.4 mmol) of ammonium dimolybdate (d50 of 20-25 μm, Climax Molybdenum Company) and 400.0 g of deionized water were added to a beaker at 88° C. to create a slurry. Once both were well mixed, the ammonium dimolybdate solution was pumped into the reactor vessel containing the molybdenum trioxide solution with zinc borate particles at 8 mL/min with a peristaltic pump. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 7, 36.0 g (250.1 mmol) of molybdenum trioxide (Langeloth Metallurgical Company) and 8.0 L of deionized water were placed into a reactor vessel equipped with a stirrer and a thermoregulator, and heated with stirring at 88° C. Once the molybdenum trioxide was completely dissolved, 160.0 g of talc (ABT 1000, Barretts Minerals Inc.) were added to the molybdenum trioxide solution. After mixing for 10 minutes, 15.0 g (128.4 mmol) of an ammonium hydroxide solution (30 wt. %) were then pumped into the reactor vessel containing the molybdenum trioxide solution with talc particles at 2 mL/min for 1 minute every 10 minutes with a peristaltic pump until the entire volume of the solution was transferred. The reaction mixture was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 8, 177.0 g (520.7 mmol) of ammonium dimolybdate (d50 of 20-25 μm, Climax Molybdenum Company) and 3.3 L of deionized water were placed in a reactor vessel equipped with a stirrer and a thermoregulator, and heated with stirring at 88° C. Separately, 150.0 g (1042.1 mmol) of molybdenum trioxide (Langeloth Metallurgical Company) and 600.0 g of deionized water were added to a beaker at 88° C. to create a slurry. Once the ammonium dimolybdate was completely dissolved and the molybdenum trioxide slurry was well mixed, the slurry was pumped into the reactor vessel containing the ammonium dimolybdate solution at 8 mL/min with a peristaltic pump. Then, 1308.0 g of fine precipitated aluminum hydroxide (Hydral 710) were added to the reaction mixture, which was then stirred for 8 hours at 88° C. The product mixture was then poured into a glass pan and dried in an oven at 120° C. overnight. The dried product was deagglomerated in a Henschel at 1800 rpm for 3 minutes followed by hammer milling to reduce to a specified particle size distribution.

In Example 9, 40.0 g of ammonium octamolybdate (prepared from ADM and MoO₃) and 160.0 g of fine precipitated aluminum hydroxide (Hydral 710) were placed in a polypropylene bottle, and the bottle was placed in a modified Blue M oven to tumble overnight at approximately 25° C.

X-ray powder diffraction (XRD) is an analytical technique primarily used for phase identification of a crystalline material. The material to be analyzed is finely ground and homogenized. The fundamental principles of x-ray powder diffraction (XRD) are the discovery of Max von Laue, in 1912, that crystalline substances act as three-dimensional diffraction gratings for x-ray wavelengths similar to the spacing of planes in a crystal lattice. X-ray diffraction is now a common technique for the study of crystal structures and atomic spacing. X-ray diffraction is based on constructive interference of monochromatic x-rays and a crystalline sample. These x-rays are generated by a cathode ray tube, filtered to produce monochromatic radiation, collimated to concentrate, and directed toward the sample. The interaction of the incident rays with the sample produces constructive interference (and a diffracted ray) when conditions satisfy Bragg's Law (nλ=2d sin θ). This law relates the wavelength of electromagnetic radiation to the diffraction angle and the lattice spacing in a crystalline sample. These diffracted x-rays are then detected, processed and counted. By scanning the sample through a range of 20 angles, all possible diffraction directions of the lattice should be attained due to the random orientation of the powdered material. Conversion of the diffraction peaks to d-spacings allows identification of the material because each material has a set of unique d-spacings. The d-spacing of each peak is then obtained by solution of the Bragg equation for the appropriate value of 2. Once all d-spacings have been determined, automated search/match routines compare the d's of the sample to those of known materials. Because each material has a unique set of d-spacings, matching these d-spacings provides an identification of the sample. A systematic procedure is used by ordering the d-spacings in terms of their intensity beginning with the most intense peak. Files of d-spacings for hundreds of thousands of inorganic compounds are available from the International Centre for Diffraction Data as the Powder Diffraction File (PDF).

Herein, the samples were loaded into standard or zero background sample holders and placed in a Panalytical X'pert MPD diffractometer using Cu radiation at 45 KV/40 mA. Scans were run over the range of 6° to 80° with a step size of 0.0131° and an accumulated counting time of 250 seconds per step. Once the diffraction patterns were obtained, the phases were identified with the aid of the Powder Diffraction File published by the International Centre for Diffraction Data or the Inorganic Crystal Structure Database. The amounts of the crystalline phases were determined by a Rietveld refinement.

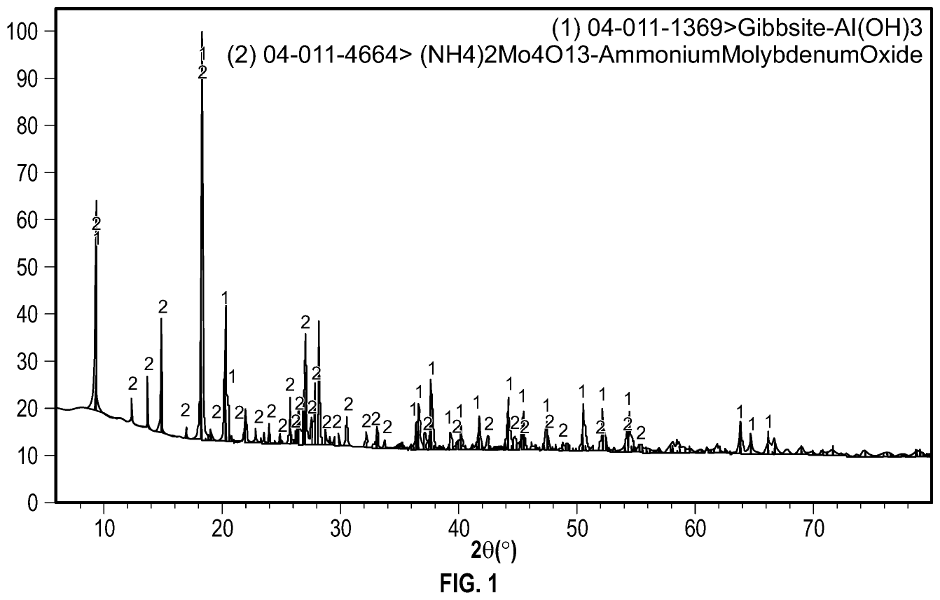

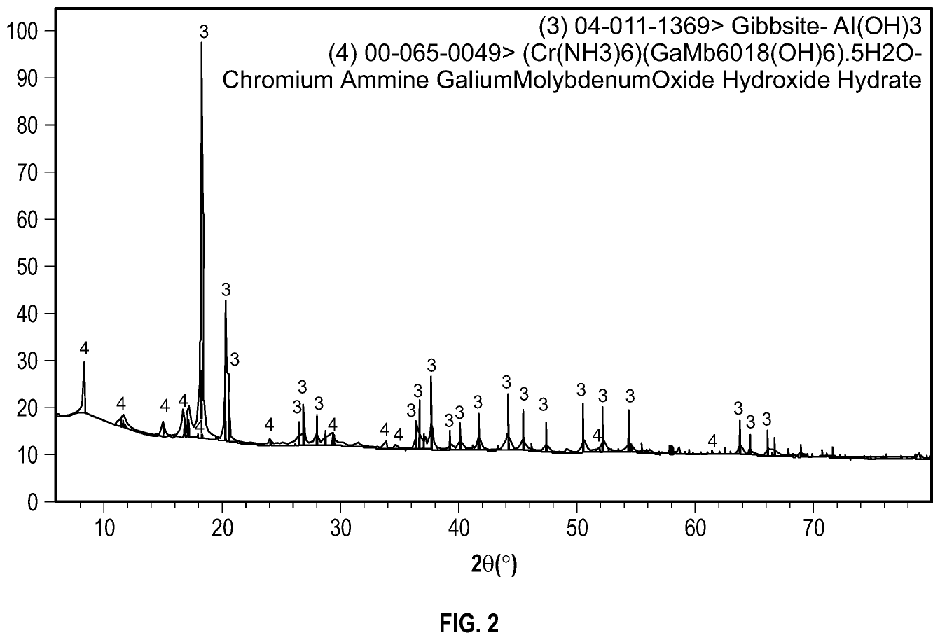

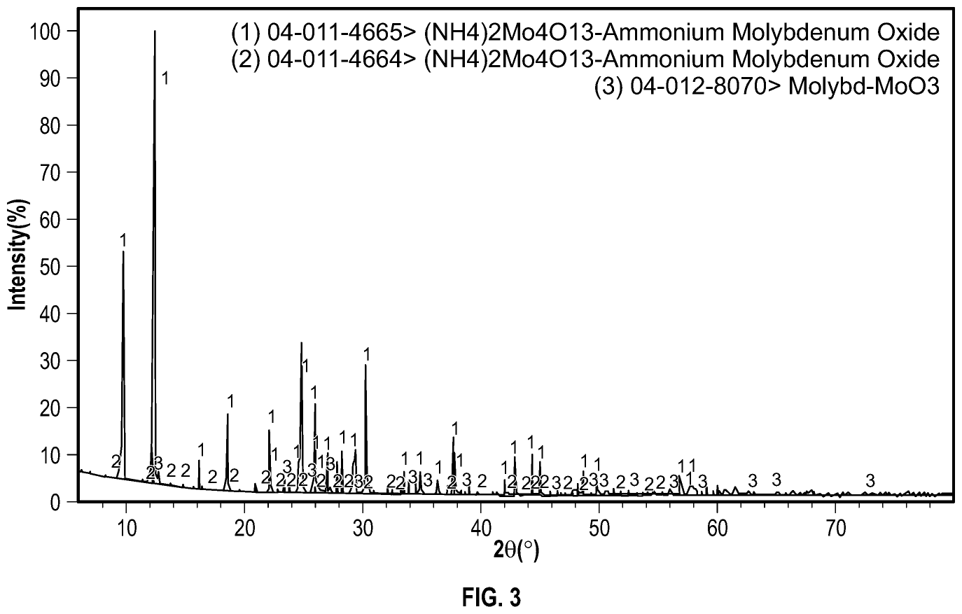

FIG. 1 is an XRD plot of the powder complex produced in Example 1, FIG. 2 is an XRD plot of the powder complex produced in Example 2, and FIG. 3 is an XRD plot of the ammonium octamolybdate mixture produced in Example 9. In addition to ATH (˜80 wt. %) and a ˜1-3 wt. % amorphous product, the complex of Example 1 (FIG. 1) contained ˜17-19 wt. % orthorhombic AOM and surprisingly, effectively all (at least 99+wt. %) of the AOM present in the complex was in the orthorhombic crystalline form. In addition to ATH (˜80 wt. %) and a ˜1-3 wt. % amorphous product, the complex of Example 2 (FIG. 2) contained ˜17-19 wt. % chromium amine gallium molybdenum oxide hydroxide hydrate, (Cr(NH₃)₆) (GaMo₆O₁₈(OH)₆)·5H₂O). Unexpectedly, no AOM was produced in Example 2, despite the fact that a type of ATH was used in both Examples 1-2. While not wishing to be bound by theory, it is believed that the presence of a higher level of gallium in the ATH of Example 2 may have prevented the formation of AOM. Example 9 was a dry blend of 80 wt. % ATH with 20 wt. % AOM, and the AOM prepared in this manner was predominantly (˜95 wt. %) alpha-AOM (triclinic crystalline form), as shown in FIG. 3, with only ˜2 wt. % orthorhombic AOM, and ˜3 wt. % unreacted MoO₃.

For the complexes of Examples 1-2 and 8-9, these complexes were incorporated into plasticized polyvinyl chloride using a two-step melt blend compounding process. In the first step, PVC, plasticizer, stabilizer, lubricant, antimony trioxide, ATH, and MgOH₂ were mixed at a temperature of 90° C. using a Henschel mixer to form a PVC pre-mix with the composition shown in Table I. In the second step, various amounts of the complexes were added to the PVC pre-mix, and then mixed at 165° C. and 45 rpm for 5 min using a Brabender Intelli-Torque Plasti-Corder mixer equipped with roller blades. Samples for analysis were prepared by pressing the material with a Givin PHI hydraulic press at a pressure of 78.3 bar and a temperature of 196° C.

TABLE I
PVC Pre-Mix Composition.

| Ingredient | Description | PHR | Wt. % | Grams |
|---|---|---|---|---|
| PVC Resin | GA Gulf 5415 (K70) | 100 | 46.88 | 2297.2 |
| Plasticizer | TOTM | 48 | 22.50 | 1102.7 |
| Stabilizer | Ca/Zn Chemson | 3 | 1.41 | 68.9 |
| Lubricant | Stearic Acid | 0.3 | 0.14 | 6.9 |
| Sb₂O₃ | Antimony Trioxide | 2 | 0.94 | 45.9 |
| ATH | Hydral 710 | 43 | 20.16 | 987.8 |
| Mg(OH)₂ | Vertex 100 | 17 | 7.97 | 390.5 |
| Total | | 213.3 | 100 | 4900 |

Table II summarizes the PVC formulations containing the complexes of Examples 1-2 and 8-9, as well as a Control Example that utilized the PVC pre-mix only, while Table III summarizes PVC formulations containing different amounts of the complex of Example 1, as well as a Control Example that utilized the PVC pre-mix only.

TABLE II
Examples 1-2 and 8-9 (phr).

| Example | Control | 1 | 2 | 8 | 9 |
|---|---|---|---|---|---|
| Pre-Mix | 213.3 | 213.3 | 213.3 | 213.3 | 213.3 |
| Example 1 complex | | 15.0 | | | |
| Example 2 complex | | | 15.0 | | |
| Example 8 complex | | | | 15.0 | |
| Example 9 complex | | | | | 15.0 |

TABLE III
Examples 1A-1B (phr).

| Example | Control | 1A | 1B |
|---|---|---|---|
| Pre-Mix | 213.3 | 213.3 | 213.3 |
| Example 1 complex | | 15.0 | |
| Example 1 complex | | | 25.0 |

A cone calorimeter (DEATAK CC-2) was used for flame resistance testing on samples following the procedure described in ASTM E 1354. Specimens measuring 100 mm×100 mm×0.635 mm were exposed in a horizontal orientation. An external heat flux of 50 kW/m² was used for the experiments. Measured parameters included Total Smoke Production (m²/m²), and Normalized Total Smoke Production (m²/m²/g). Reported data was the average of 3 experiments.

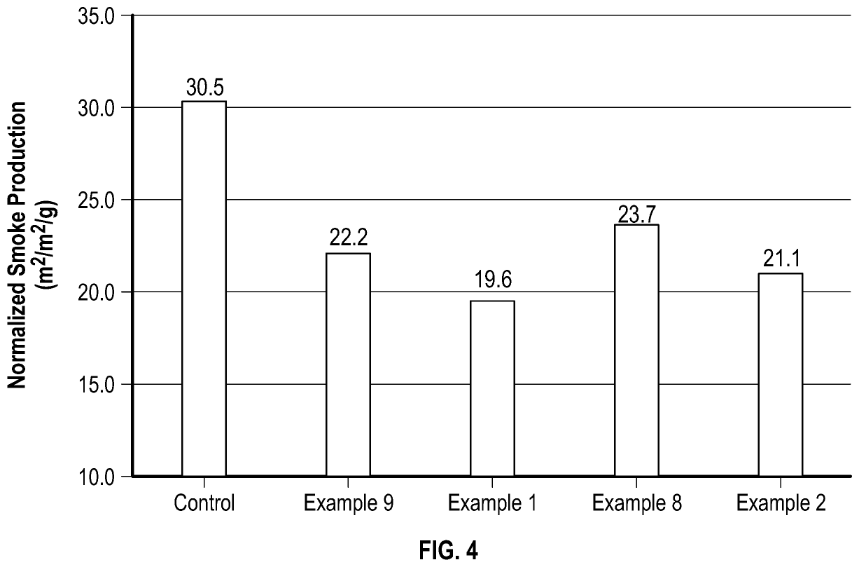

For the formulations shown in Table II, FIG. 4 is a bar chart summarizing the normalized total smoke (m²/m² per gram of the polymer composition sample) for the flexible PVC polymer compositions containing the complexes of Examples 1-2 and 8-9 at 15 phr, as well as a Control Example (which contained no smoke suppressant). As expected, each of the formulations containing a smoke suppressant complex reduced the total amount of smoke as compared to the control. However, and unexpectedly, the formulation containing the complex of Example 1 had the lowest smoke production, and resulted in ˜12-18% better smoke suppressant performance than the formulations containing the complexes of Examples 8-9, and ˜7% better smoke suppressant performance than the formulation containing the ground ATH-based complex of Example 2. Surprisingly, the formulation containing the complex of Example 1 (AOM bound to the ATH) had significantly better smoke suppressant performance than the formulation containing the complex of Example 9 (physical blend of AOM and ATH).

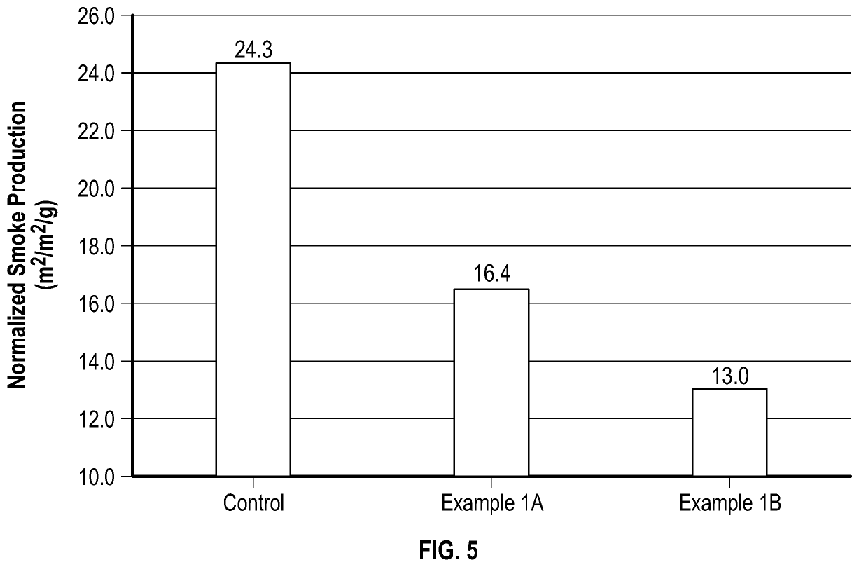

For the formulations shown in Table III, FIG. 5 is a bar chart summarizing the normalized total smoke (m²/m² per gram of the polymer composition sample) for the flexible PVC polymer compositions containing the complex of Example 1 at 15 phr (1A) and 25 phr (1B), as well as a Control Example (which contained no smoke suppressant). By increasing the loading of the smoke suppressant to 25 phr from 15 phr, the total smoke production of the Control Example was reduced by almost 50%.

For the complex of Example 1 and for ammonium octamolybdate (AOM), these materials were incorporated into plasticized polyvinyl chloride using the process described above. The PVC pre-mix had the composition shown in Table IV. Example 1 at 15 phr (Example 1C) and AOM at 15 phr (Example 10) were tested in the formulation of Table IV and compared to a Control Example that utilized the PVC pre-mix only.

TABLE IV
PVC Pre-Mix Composition.

| Ingredient | Description | PHR | Wt. % |
|---|---|---|---|
| PVC Resin | Axial 5415 | 100 | 46.9 |
| Plasticizer | TOTM | 48 | 22.5 |
| Stabilizer | Plastistab 2148 | 3 | 1.4 |
| Lubricant | Stearic Acid | 0.3 | 0.1 |
| Sb₂O₃ | Antimony Trioxide | 2 | 0.9 |
| ATH | Hydral 710 | 43 | 20.2 |
| Mg(OH)₂ | Vertex 100 | 17 | 8.0 |
| Total | | 213.3 | 100.0 |

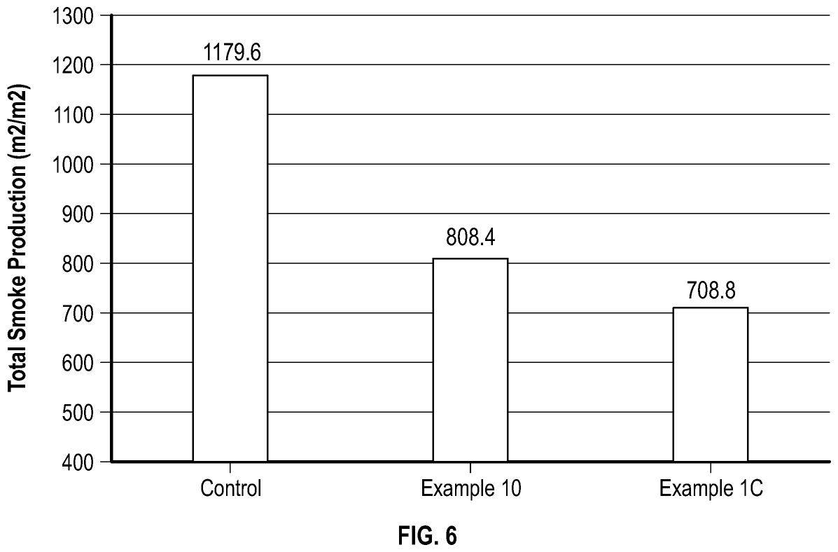

FIG. 6 is a bar chart summarizing the total smoke (m²/m²) for the flexible PVC polymer compositions containing the complex of Example 1 at 15 phr (Example 1C), AOM at 15 phr (Example 10), as well as a Control Example (which contained no smoke suppressant). As expected, each of the formulations containing a smoke suppressant complex dramatically reduced the total amount of smoke as compared to the control. However, and unexpectedly, the formulation of Example 1C (containing the complex of Example 1) had lower smoke production and ˜12% better smoke suppressant performance than the formulation containing 100% AOM. This is particularly beneficial, since AOM is much more expensive than ATH, yet Example 1 contained only ˜20 wt. % AOM while Example 10 contained 100% AOM, and the performance of Example 1C (containing the complex of Example 1) was superior to that of Example 10.

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A process comprising: reacting ammonium dimolybdate (ADM), molybdenum trioxide (MoO₃), and a metal hydroxide in an aqueous system to form an ammonium octamolybdate/metal hydroxide complex.

Aspect 2. The process defined in aspect 1, wherein the metal hydroxide comprises aluminum trihydroxide.

Aspect 3. The process defined in aspect 1, wherein the metal hydroxide comprises magnesium dihydroxide.

Aspect 4. The process defined in any one of aspects 1-3, wherein the process comprises pre-contacting the ammonium dimolybdate (ADM) and the metal hydroxide, and then contacting the molybdenum trioxide (MoO₃).

Aspect 5. The process defined in any one of aspects 1-3, wherein the process comprises contacting the ammonium dimolybdate (ADM), the molybdenum trioxide (MoO₃), and the metal hydroxide substantially contemporaneously.

Aspect 6. The process defined in any one of aspects 1-5, wherein the process is conducted (or the complex is formed) at a temperature in any suitable range, or in any range disclosed herein, e.g., from 20° C. to 98° C., from 50° C. to 90° C., from 75° C. to 90° C., or from 80° C. to 98° C.

Aspect 7. The process defined in any one of aspects 1-6, wherein the molybdenum trioxide (MoO₃) and the ammonium dimolybdate (ADM) are reacted at a molar ratio of MoO₃:ADM in any suitable range, or in any range disclosed herein, e.g., from 1:1 to 3:1, from 1.2:1 to 2.8:1, from 1.5:1 to 2.5:1, or from 1.8:1 to 2.4:1, based on the total amount of each reactant.

Aspect 8. The process defined in any one of aspects 1-7, wherein the process is conducted (or the complex is formed) at a pressure in any suitable range, or in any range disclosed herein, e.g., from 5 psig to 100 psig, at atmospheric pressure, or at a sub-atmospheric pressure.

Aspect 9. The process defined in any one of aspects 1-8, further comprising a step of removing the complex from water using any suitable technique, or any technique disclosed herein, e.g., filtration or centrifugation, as well as combinations thereof.

Aspect 10. The process defined in any one of aspects 1-9, further comprising a step of drying the complex under any suitable drying conditions, or any drying conditions disclosed herein, e.g., a drying temperature in a range from 50° C. to 200° C., or from 100° C. to 150° C., and drying at atmospheric pressure or sub-atmospheric pressure, e.g., less than 150 Torr, or less than 50 Torr.

Aspect 11. The process defined in any one of aspects 1-10, further comprising a step of deagglomerating the complex, a step of milling the complex, or both.

Aspect 12. The process defined in any one of aspects 1-11, wherein the metal hydroxide has a soluble Na₂O content in any suitable range, or in any range disclosed herein, e.g., from 0.001 to 0.035 wt. %, from 0.001 to 0.03 wt. %, from 0.001 to 0.018 wt. %, from 0.002 to 0.035 wt. %, from 0.002 to 0.025 wt. %, or from 0.002 to 0.02 wt. %.

Aspect 13. The process defined in any one of aspects 1-12, wherein the metal hydroxide is characterized by a TAPPI brightness in any suitable range, or in any range disclosed herein, e.g., greater than or equal to 95%, greater than or equal to 97%, greater than or equal to 98%, or greater than or equal to 99%.

Aspect 14. The process defined in any one of aspects 1-13, wherein the metal hydroxide is characterized by any suitable median particle size (d50), or a median particle size (d50) in any range disclosed herein, e.g., from 0.5 to 5 μm, from 0.5 to 3 μm, from 0.75 to 2 μm, or from 0.75 to 1.75 μm.

Aspect 15. The process defined in any one of aspects 1-14, wherein the metal hydroxide is characterized by any suitable BET surface area, or a BET surface area in any range disclosed herein, e.g., from 1 to 20 m²/g, from 1 to 15 m²/g, from 2 to 10 m²/g, or from 2 to 6 m²/g.

Aspect 16. The process defined in any one of aspects 1-15, wherein the metal hydroxide contains any suitable amount of gallium (in ppm by weight), or an amount of gallium in any range disclosed herein, e.g., less than or equal to 29 ppm, less than or equal to 27 ppm, less than or equal to 25 ppm, less than or equal to 23 ppm, less than or equal to 20 ppm, less than or equal to 15 ppm, or less than or equal to 10 ppm.

Aspect 17. The process defined in any one of aspects 1-16, wherein the metal hydroxide comprises precipitated ATH.

Aspect 18. The process defined in any one of aspects 1-17, wherein the molybdenum trioxide is characterized by any suitable median particle size (d50), or a median particle size (d50) in any range disclosed herein, e.g., from 0.5 to 20 μm, from 1 to 10 μm, or from 1.6 to 6 μm.

Aspect 19. The ammonium octamolybdate/metal hydroxide complex produced by the process defined in any one of aspects 1-18, wherein the complex comprises any suitable amount of AOM, or an amount in any range disclosed herein, e.g., from 1 to 95 wt. %, from 5 to 80 wt. %, from 5 to 50 wt. %, from 10 to 60 wt. %, or from 10 to 30 wt %.

Aspect 20. An ammonium octamolybdate/metal hydroxide complex comprising ammonium octamolybdate and a metal hydroxide, wherein the complex comprises any suitable amount of AOM, or an amount in any range disclosed herein, e.g., from 1 to 95 wt. %, from 5 to 80 wt. %, from 5 to 50 wt. %, from 10 to 60 wt. %, or from 10 to 30 wt. %.

Aspect 21. The process or complex defined in any one of aspects 1-20, wherein any suitable amount, or an amount in any range disclosed herein, e.g., at least 80 wt. %, at least 85 wt. %, at least 90 wt. %, at least 95 wt. %, at least 98 wt. %, or at least 99 wt. %, of the ammonium octamolybdate is present in an orthorhombic crystalline form.

Aspect 22. The process or complex defined in any one of aspects 1-21, wherein the complex comprises any suitable amount of gallium (in ppm by weight), or an amount of gallium in any range disclosed herein, e.g., less than or equal to 29 ppm, less than or equal to 27 ppm, less than or equal to 25 ppm, less than or equal to 23 ppm, less than or equal to 20 ppm, less than or equal to 15 ppm, less than or equal to 10 ppm, or less than or equal to 5 ppm.

Aspect 23. The process or complex defined in any one of aspects 1-22, wherein the complex is characterized by any suitable median particle size (d50), or a median particle size (d50) in any range disclosed herein, e.g., from 0.5 to 10 μm, from 1 to 10 10 μm, or from 1 to 6 μm.

Aspect 24. The process or complex defined in any one of aspects 1-23, wherein the complex is characterized by any suitable BET surface area, or a BET surface area in any range disclosed herein, e.g., from 2 to 20 m²/g, from 3 to 18 m²/g, from 4 to 15 m²/g, or from 5 to 12 m²/g.

Aspect 25. The process or complex defined in any one of aspects 1-24, wherein the metal hydroxide in the complex (or the complex) has a soluble Na₂O content in any suitable range, or in any range disclosed herein, e.g., from 0.001 to 0.035 wt. %, from 0.001 to 0.03 wt. %, from 0.001 to 0.018 wt. %, from 0.002 to 0.035 wt. %, from 0.002 to 0.025 wt. %, or from 0.002 to 0.02 wt. %.

Aspect 26. The process or complex defined in any one of aspects 1-25, wherein the metal hydroxide in the complex (or the complex) is characterized by a TAPPI brightness in any suitable range, or in any range disclosed herein, e.g., greater than or equal to 95%, greater than or equal to 97%, greater than or equal to 98%, or greater than or equal to 99%.

Aspect 27. The process or complex defined in any one of aspects 1-26, wherein the complex comprises AOM bound to the metal hydroxide.

Aspect 28. The process or complex defined in any one of aspects 1-27, wherein the complex is spherical.

Aspect 29. A polymer composition (or formulation) comprising: (a) a polymer, and (b) the ammonium octamolybdate/metal hydroxide complex defined in any one of aspects 19-28.

Aspect 30. The polymer composition defined in aspect 29, wherein the amount of the complex in the polymer composition is any suitable amount, or an amount in any range disclosed herein, e.g., from 1 to 50 phr, from 5 to 50 phr, from 2 to 40 phr, from 5 to 40 phr, from 10 to 50 phr, from 10 to 40 phr, from 10 to 30 phr, or from 15 to 40 phr.

Aspect 31. The polymer composition defined in aspect 29 or 30, wherein the polymer comprises any suitable polymer, or any polymer disclosed herein, e.g., a thermoplastic, a thermoset, or a combination thereof.

Aspect 32. The polymer composition defined in aspect 29 or 30, wherein the polymer comprises a polyvinylidene chloride (PVDC), a polyvinyl chloride (PVC), a chlorinated polyvinyl chloride (CPVC), a polyvinylidene fluoride (PVDF), a polytetrafluoroethylene (PTFE), an ethylene chlorotrifluoroethylene (ECTFE), or any combination thereof.

Aspect 33. The polymer composition defined in aspect 29 or 30, wherein the polymer comprises a rigid PVC.

Aspect 34. The polymer composition defined in aspect 29 or 30, wherein the polymer comprises a flexible PVC.

Aspect 35. The polymer composition defined in aspect 29 or 30, wherein the polymer comprises a plasticized or non-plasticized PVC.

Aspect 36. The polymer composition defined in aspect 29 or 30, wherein the polymer comprises an epoxy resin.

Aspect 37. The polymer composition defined in aspect 29 or 30, wherein the polymer comprises a bisphenol A epoxy resin, a bisphenol F epoxy resin, a bisphenol S epoxy resin, a phenol novolac epoxy resin, a cresol novolac epoxy resin, a bisphenol A novolac epoxy resin, a bisphenol F novolac epoxy resin, a diphenylethylene epoxy resin, an epoxy resin having a triazine skeleton, an epoxy resin having a fluorene skeleton, a triphenylmethane epoxy resin, a biphenyl epoxy resin, a xylylene epoxy resin, a biphenyl aralkyl epoxy resin, a naphthalene epoxy resin, a dicyclopentadiene epoxy resin, an alicyclic epoxy resin, or any combination thereof.

Aspect 38. The polymer composition defined in any one of aspects 29-37, wherein the polymer composition further comprises an additive, the additive comprising a stabilizer, a lubricant, an inorganic flame retardant (e.g., aluminum trihydrate or magnesium hydroxide), a filler, a colorant, or a curing agent, as well as any combination thereof.

Aspect 39. An article of manufacture comprising the polymer composition defined in any one of aspects 29-38.

Aspect 40. The article defined in aspect 39, wherein the article comprises a wire or cable.

Aspect 41. The article defined in aspect 39, wherein the article comprises a printed circuit board.

We claim:

1. An ammonium octamolybdate/metal hydroxide complex comprising:
ammonium octamolybdate (AOM); and
a metal hydroxide;
wherein the complex comprises from 1 to 95 wt. % of the AOM.

2. The complex of claim 1, wherein the complex comprises from 15 to 35 wt. % of the AOM.

3. The complex of claim 1, wherein the metal hydroxide comprises aluminum trihydroxide (ATH).

4. The complex of claim 1, wherein the metal hydroxide comprises precipitated ATH.

5. The complex of claim 1, wherein at least 80 wt. % of the ammonium octamolybdate in the complex is present in an orthorhombic crystalline form.

6. The complex of claim 1, wherein at least 98 wt. % of the ammonium octamolybdate in the complex is present in an orthorhombic crystalline form.

7. The complex of claim 1, wherein the complex contains less than or equal to 25 ppm by weight of gallium.

8. The complex of claim 1, wherein the complex has:
a soluble Na₂O content from 0.001 to 0.035 wt. %; or
a TAPPI brightness of greater than or equal to 95%; or
a d50 particle size from 0.5 to 10 μm; or
a BET surface area from 2 to 20 m²/g; or
any combination thereof.

9. The complex of claim 1, wherein the complex comprises AOM bound to ATH.

10. The complex of claim 1, wherein the complex is spherical.

11. A polymer composition comprising:
(a) a polymer; and
(b) the ammonium octamolybdate/metal hydroxide complex of claim 1.

12. The polymer composition of claim 11, wherein the polymer comprises a rigid PVC or a flexible PVC.

13. The polymer composition of claim 11, wherein the polymer comprises an epoxy resin.

14. The polymer composition of claim 11, wherein an amount of the ammonium octamolybdate/metal hydroxide complex in the polymer composition is in a range from 1 to 50 phr.

15. The polymer composition of claim 11, wherein the polymer composition further comprises an additive, the additive comprising a stabilizer, a lubricant, an inorganic flame retardant, a filler, a colorant, a curing agent, or any combination thereof.

16. An article of manufacture comprising the polymer composition of claim 11.

17. A process comprising:
reacting ammonium dimolybdate (ADM), molybdenum trioxide (MoO₃), and a metal hydroxide in an aqueous system to form an ammonium octamolybdate/metal hydroxide complex.

18. The process of claim 17, wherein:
the complex is formed at a temperature in a range from 20° C. to 98° C.; and
the molybdenum trioxide (MoO₃) and the ammonium dimolybdate (ADM) are reacted at a molar ratio of MoO₃:ADM from 1.2:1 to 2.8:1.

19. The process of claim 17, wherein:
the process comprises pre-contacting the ammonium dimolybdate (ADM) and the metal hydroxide, and then contacting the molybdenum trioxide (MoO₃); and
the process further comprises a step of removing the complex from water.

20. The process of claim 19, further comprising:
drying the complex;
deagglomerating the complex;
milling the complex; or
any combination thereof.

21. The process of claim 17, wherein:
the molybdenum trioxide (MoO₃) has a d50 particle size from 0.5 to 20 μm; and
the metal hydroxide has:
a soluble Na₂O content from 0.001 to 0.035 wt. %;
a TAPPI brightness of greater than or equal to 95%;
a d50 particle size from 0.5 to 5 μm; and
a BET surface area from 1 to 20 m²/g.

22. The process of claim 17, wherein the metal hydroxide contains less than or equal to 29 ppm by weight of gallium.
